(19) United States
(12) Patent Application Publication
(10) Pub. No.: US 2005/0213118 A1
(43) Pub. Date: Sep. 29, 2005

(54) Image data converter, image data conversion program storage medium, and image output system

(75) Inventors: Nobuyuki Shitara, Kanagawa (JP); Tetsuya Sano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/089,462

(22) Filed: Mar. 25, 2005

(30) Foreign Application Priority Data
Mar. 25, 2004 (JP) 2004-090014
Mar. 8, 2005 (JP) 2005-063597

(51) Int. Cl. G06K 15/02; G06T 11/00; G06F 17/00; H04N 1/387

(52) U.S. Cl. 358/1.1; 715/523; 715/511; 358/1.18

(57) ABSTRACT

The present invention enables sharing of a master image. An image data converter of the present invention has: a data acquisition section that acquires master data representing a master component of plural versions of an image that are partially common, which is a component common among the versions, in the first format and variable data representing variable components of the plural versions of the image, which are components differing among the versions, in the first format; a data conversion section that converts the master data and the variable data into master separate-plate data and variable separate-plate data in the second format, respectively; and a data output section that outputs the master separate-plate data and the variable separate-plate data to plural input lines of an image output device.

### BACKGROUND OF THE INVENTION

1. Field of the Invention

The present invention relates to a data converter that converts image data into image data representing an image in a format suitable for a predetermined image output device, an image data conversion program storage medium and an image output system for converting image data into a format suitable for an image output device and makes the image output device output the resulting image.

2. Description of the Related Art

In recent years, computerization of printing technology has been advanced, and it has become common practice to edit a page of a printing with an editing computer using, as an original, image data that represents an image of the page with the positions of characters or photographs in the page defined. Once receiving image data as an original, a printing office or the like separates the image data into four colors of cyan (C), magenta (M), yellow (Y) and black (K) used for printing to form images of printing plates (that is, raster images) of the four colors, produces printing plates bearing dot images of the four colors of C, M, Y and K from the raster images, and installs the printing plates into a printing machine, and the printing machine prints the dot images of the four colors of C, M, Y and K in an overlaid manner using inks of the colors of C, M, Y and K. In this way, a printing of a color image composed of plural dot images is produced. In addition, if a color is used which is difficult to represent by overlaying the four process colors or a color is used which requires high color precision, printing is performed using a spot color ink and a spot-color printing plate in addition to the process color inks and the printing plates for the process colors.

The process of producing a raster image from image data, producing a printing plate and performing printing by a printing machine requires much time and effort, and conventionally, preceding to performing such a printing process, a proof process is performed. The proof process involves producing a proof image that resembles the image of the printing using a convenient image output device, such as a printer, checking the proof image for the-quality of the finished printing, and correcting the original if necessary. In this process, to convert the image data about the original into image data suitable for the image output device, an image data converter or an image data conversion program is used. An image output system that has such an image output device, image data converter or the like and produces a proof image based on the image data about the original is sometimes referred to as a proofing system.

Various types of such image output devices for the proofing system are known. A common one is of a plate-less type that outputs an image using four color materials of C, M, Y and K corresponding to the process colors. The kinds of the process colors are predetermined. However, colors of spot color inks are variable, and therefore, of course, the image output device does not have any color materials corresponding to spot color inks. Thus, when the proofing system outputs a printing that is expected to use a spot color ink, the image data converter or image data conversion program separates the spot color into process colors, and the images resulting from the color separation of the spot color are overlaid on the original process color images to form an image that represents the printing only by the process colors, thereby reproducing all the colors including the spot color using only the four color materials of C, M, Y and K.

In the case where a printing is translated into plural languages, for example, it is common practice to produce plural versions of the printing. If such plural versions of the printing consist of plural pages, some of the pages contain components different among the plural languages, and the remaining pages are common among the languages, the plural versions of the printing can be efficiently produced by sharing the common pages and replacing only the different pages with adequate ones.

Besides, if plural versions of a printing consist of one page, or if plural versions of a printing consist of plural pages and each page contains a component differing among the languages, the page replacement described above cannot be performed. However, a common component can be shared among the plural languages if only the different component in each page is electronically replaced with an adequate one on the editing computer described above.

If such electronic replacement is used for producing plural versions of a printing, a common component can be shared when producing an original. However, in the step of producing a raster image from the image of the original, the step of producing a printing plate base on the raster image, the step of installing the printing plate in a printing machine and performing printing and the like, such electronic replacement requires the same process to be repeatedly performed for each of the plural versions including the common component, which leads to wasted time, effort, resources and the like.

Thus, there has been proposed a technique referred to as versioning described below.

According to the technique referred to as versioning, in a raster image producing step, raster images are produced separately for a master component common among plural versions of a printing and for variable components differing among the plural versions. That is, the master component of an original is managed as a processing image for printing represented by four process color inks of C, M, Y and K, and the variable components of the original are managed as spot color images for a spot color ink for convenience. In a raster image producing step, the master component is separated into the four color of C, M, Y and K to form raster images of the colors, and as for the variable components, the raster images thereof are produced as images of spot-color printing plates. In a printing plate producing step, as for the master component, a set of printing plates for the colors C, M, Y and K are produced from the raster images, and as for the variable components, spot-color printing plates for the plural versions are produced from the respective raster images. In a printing step, printing is performed using the spot-color printing plate for each version while sharing the set of printing plates of the colors of C, M, Y and K. Here, the ink actually used for printing of the spot-color printing plate of each variable component is not the spot color ink that is used for convenience in managing the original and may be an ink of a color preferred for representing the variable component and may be an ink of one of the process colors.

Such versioning allows the master component to be shared from the original stage to the printing-plate stage and allows the variable component to be replaced with an adequate one by using a spot-color handling section of a conventional printing system. Thus, plural versions of a printing can be produced efficiently.

Although such a technique referred to as versioning is well known, there is a few literature in which the technique is described. However, for example, the technique is described in “CELEBRANT RIP PURCHASABLE OPTION USER MANUAL 6800123000 (Chapter 10 “Versioning”)”, FUJI FILM ELECTRONIC IMAGING LTD., December 2002.

However, if such versioning is applied to the case of producing proof images for plural versions of a printing by the proofing system described above, the proofing system receives image data that specifies the variable components as spot-color images for convenience. Then, in the proofing system, the image data converter or image data conversion program has to perform the image processing calculation for separating the spot color into the process colors, including the image processing calculation for the master component, each time a variable component is replaced with adequate one. Such an image processing calculation is a great load on the image data converter or the proofing system, and there is a problem that the advantage of the versioning that plural versions of a printing can be efficiently produced by sharing the master component is compromised.

Such a problem occurs not only in the proofing system but also in cases where an on-demand printing system, which produces a printing directly from image data without using any plate, produces plural versions of a printing or where an image output system for fields other than printing produces plural versions of an image.

### SUMMARY OF THE INVENTION

The present invention has been made in view of the above circumstances and provides an image data converter that allows efficient sharing of a master component, an image data conversion program storage medium, and an image output system.

According to the present invention, there is provided a first image data converter that converts input image data representing an image in a first format into to-be-output image data in a second format suitable for output by a predetermined image output device that receives image data via a continuous-tone input line and a line-work input line and outputs a composite image obtained by overlaying images represented by the image data, the image data converter including:
a data acquisition section that acquires input master data and input variable data, the master data representing a master component of plural versions of the image that are partially common, which is a component common among the versions, in the first format, and the variable data representing variable components of the plural versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

The first image data converter according to the present invention uses the image output device having the continuous-tone input line and the line-work input line simply as an image output device capable of outputting images represented by the image data received via the two input lines in an overlaid manner, while neglecting the original purposes of the continuous-tone input line and the line-work input line. Consequently, the master data having been converted in the second format can be repeatedly used, and the image output device can be made to output plural versions of an image by efficiently sharing the master component.

According to a typical implementation, in the first image data converter according to the present invention, the data acquisition section acquires input master data representing the master component by a process color and input variable data representing the variable component by a spot color.

As for the image data for versioning described above, the master component is represented by process colors, and the variable components are represented by a spot color, and according to this typical implementation, the image data for versioning is used, so that the variable components can be readily recognized.

In the first image data converter according to the present invention, preferably, the data conversion section converts the input master data and the input variable data in the first format into the to-be-output master data and the to-be-output variable data in the second format so as to obtain common to-be-output master data and a plurality of pieces of to-be-output variable data,
the image data converter further includes:
a master data storage section that stores the common to-be-output master data;
a variable data storage section that stores the plurality of pieces of to-be-output variable data; and
a variable data selection section that selects one of the plurality of pieces of to-be-output variable data stored in the variable data storage section, and
the output section outputs the to-be-output data stored in the master data storage section and the one piece of to-be-output variable data selected by the variable data selection section.

The first image data converter in this preferable mode can freely outputs an image of a desired version by using common output master data.

According to the present invention, there is provided a second image data converter that converts input image data representing an image in a first format into to-be-output image data in a second format suitable for output by a predetermined image output device that receives image data via plural input lines and outputs a composite image obtained by overlaying images represented by the image data, the image data converter including:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plural input lines of the image output device.

The second image data converter according to the present invention can output plural versions of an image by efficiently sharing a master component through an image output device that is capable of recognizing variable components based on a spot color and outputting a composite image obtained by overlaying images.

According to the present invention, there is provided a first image data conversion program storage medium that stores an image data conversion program that is incorporated in a computer system and makes the computer system convert input image data representing an image in a first format into to-be-output image data in a second format suitable for output by a predetermined image output device that receives image data via a continuous-tone input line and a line-work input line and outputs a composite image obtained by overlaying images represented by the image data, the image data conversion program including:
a data acquisition section that acquires input master data and input variable data, the master data representing a master component of plural versions of the image that are partially common, which is a component common among the versions, in the first format, and the variable data representing variable components of the plural versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

According to the present invention, there is provided a second image data conversion program storage medium that stores an image data conversion program that is incorporated in a computer system and makes the computer system convert input image data representing an image in a first format into to-be-output image data in a second format suitable for output by a predetermined image output device that receives image data via plural input lines and outputs a composite image obtained by overlaying images represented by the image data, the image data conversion program including:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plural input lines of the image output device.

In addition, according to the present invention, there is provided a first image output system that has a predetermined image output device that receives image data via a continuous-tone input line and a line-work input line and outputs a composite image obtained by overlaying images represented by the image data, converts input image data representing an image in a first format into to-be-output image data in a second format suitable for output by the image output device, and outputs the image from the image output device, the image output system including:
a data acquisition section that acquires input master data and input variable data, the master data representing a master component of plural versions of the image that are partially common, which is a component common among the versions, in the first format, and the variable data representing variable components of the plural versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

According to the present invention, there is provided a second image output system that has a predetermined image output device that receives image data via plural input lines and outputs a composite image obtained by overlaying images represented by the image data, converts input image data representing an image in a first format into to-be-output image data in a second format suitable for output by the image output device, and outputs the image from the image output device, the image output system including:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plural input lines of the image output device.

Here, as for the image data conversion program and the image output system of the present invention, only basic forms thereof are described in this specification. However, this is merely intended to avoid redundancy, and the image data conversion program and the image output system of the present invention can have various forms corresponding to various forms of the image data converter described above, besides the basic forms described herein.

Furthermore, the image data converter, the image output system and the image data conversion program of the present invention have components of the same names, such as “data acquisition section” and “data conversion section”. However, although sharing the same names, the components of the image data conversion program are software that provides such functions, and the components of the image data converter and the image output system are hardware or software.

Furthermore, as for the components, such as the data conversion section, of the image data conversion program of the present invention, the function of each component may be provided by one program component or by plural program components, or functions of plural components maybe provided one program component. Furthermore, the components may perform their functions by themselves or may instruct another program or program component in the computer to perform the functions.

As described above, according to the present invention, the master component can be shared, and therefore, plural versions of an image can be efficiently produced.

### BRIEF DESCRIPTION OF THE DRAWINGS

FIG. 1 shows a proofing system incorporating an embodiment of the present invention;

FIG. 2 is a conceptual diagram showing plural versions of a printing represented by image data;

FIG. 3 shows a hardware configuration of a computer serving as an image data converter;

FIG. 4 shows an image data conversion program storage medium according to an embodiment of the present invention; and

FIG. 5 is a functional block diagram showing the image data converter.

### DETAILED DESCRIPTION OF THE INVENTION

In the following, embodiments of the present invention will be described with reference to the drawings.

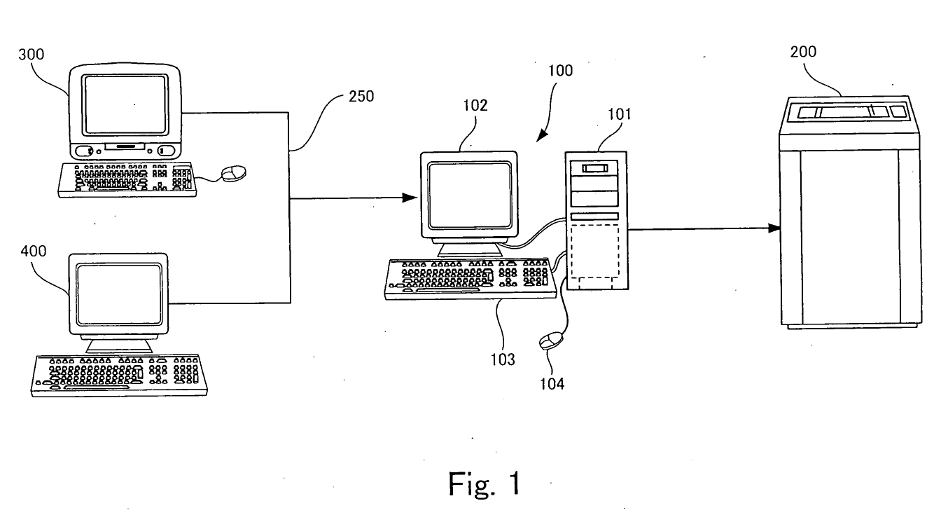

FIG. 1 shows a proofing system incorporating an embodiment of the present invention.

The proofing system shown in FIG. 1 has a computer serving as an image data converter 100 and a proofer 200.

To the image data converter 100, computers serving as editor devices 300 and 400 are connected via a communication network 250. The editor devices 300 and 400 edit image data that represents a printing in a page description language and transmit the edited image data to the image data converter 100 via the communication network 250.

Upon receiving the image data from the editor device 300 or 400, the image data converter 100 converts the image data into image data that represents the image by four raster images of colors C, M, Y and K that can be handled by the proofer 200 and outputs the resulting image data to the proofer 200. Here, the image data converter 100 may receive the image data not only via the communication network 250 but also via a recording medium, such as a compact disk recordable (CD-R) disk and a magneto-optical (MO) disk.

The proofer 200 outputs an image that is represented by four color materials of C, M, Y and K based on the image data. When the proofer 200 receives the image data representing the image by the four raster images of C, M, Y and K, which is obtained by the conversion by the image data converter 100, the proofer 200 reproduces the four raster images of C, M, Y and K using the four color materials of C, M, Y and K and outputs a proof image reproduced by the four color materials C, M, Y and K.

Here, the proofer 200 has two input lines for receiving two types of input data via common hardware. One of the two input lines is for continuous-tone data, such as a photograph or illustration, and the other is for line-work data, such as a character or rule. The editor devices 300 and 400 may use a technique of producing image data by editing the continuous-tone data and the line-work data in separate electronic layers to make it easy to reedit the image data after checking the finished image using the proof image. Since the proofer 200 has such plural input lines, the proofer 200 can accept and output the plural layers of image data produced through such a technique as they are, so that the load of data conversion on the image data converter 100 can be reduced.

Here, the editor devices 300 and 400 have a capability of editing plural versions of a printing and producing a group of image data for versioning that represents the plural versions of the printing. In the following, a case where such a group of image data is transmitted to the image data converter 100 of the proofing system will be described. In the following description, such a group of image data will sometimes be referred to simply as “image data”.

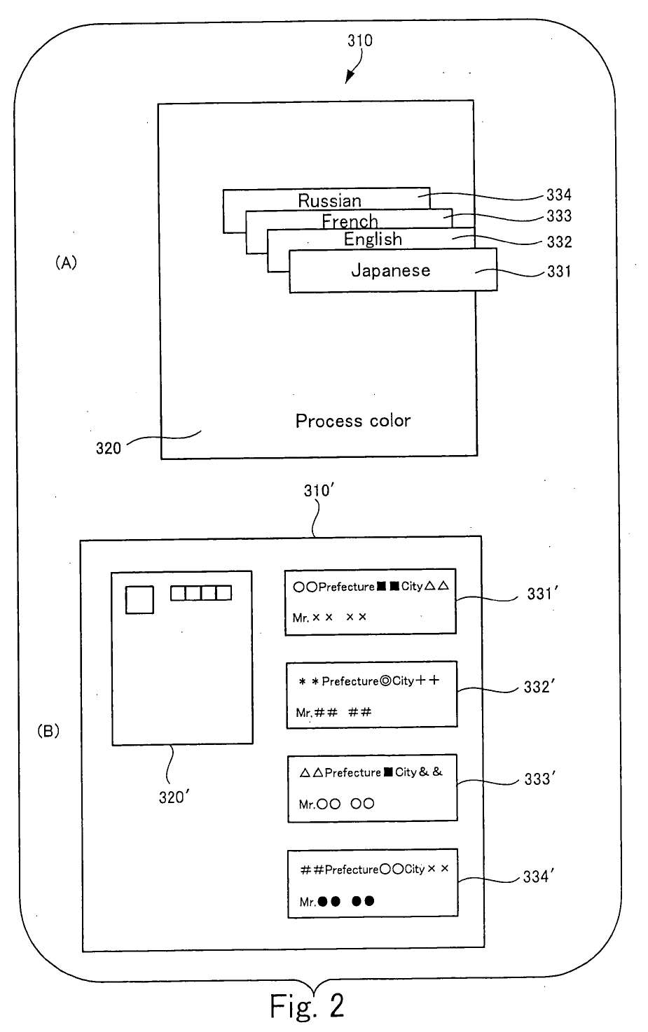

FIG. 2 is a conceptual diagram showing plural versions of a printing represented by image data.

As an example of a group of image data for versioning, Part (A) of FIG. 2 shows image data 310 that represents four versions of a printing for Japanese, English, French and Russian. The image data 310 contains one piece of master data 320 that represents a master component, which is shared among the four versions, by the four colors of C, M, Y and K and four pieces of variable data 331, 332, 333 and 334 that represent four variable components differing among the four versions as spot color plates for the respective versions. Each piece of variable data 331, . . . , 334 includes a specification about the color used in actual printing of the spot color plate. A common color may be specified for the four versions, or a certain process color, such as black, may be specified for a certain version. A combination of one of the four pieces of variable data 331, . . . and 334 and the master data 320 represents one version of the printing.

As another example of a group of image data for versioning, Part (B) of FIG. 2 shows image data 310′ that represents four versions of a postal mail printing for plural destinations. The image data 310′ contains one piece of master data 320′ that represents a master component, which is shared among the four versions, by the four colors of C, M, Y and K and four pieces of variable data 331′, 332′, 333′ and 334′ that represent four variable components differing among the four versions as spot color plates for the respective versions.

For the above-described data for versioning, more than one color may be used in variable components represented by variable data in some cases. In the following description however, a single color is used in variable components for convenience.

In the proofing system shown in FIG. 1, when the image data converter 100 receives image data representing such plural versions of a printing, the proofer 200 can output proof images for the respective versions. A characteristic of the proofing system according to this embodiment of the present invention lies in the operation of the computer serving as the image data converter 100. Thus, in the following, the image data converter 100 will be described in particular.

The image data converter 100 shown in FIG. 1 is constituted by a computer as described above, and the computer has a main unit 101 incorporating a CPU, a main storage device, a hard disk, a communication board and the like, a CRT display 102 that displays an image or a character string on a display screen in response to an instruction from the main unit 101, a keyboard 103 for a user to enter an instruction or text information to the computer, and a mouse 104 that points at an icon or the like displayed at any point in the display screen of the CRT display 102 for entering the instruction assigned to the icon or the like.

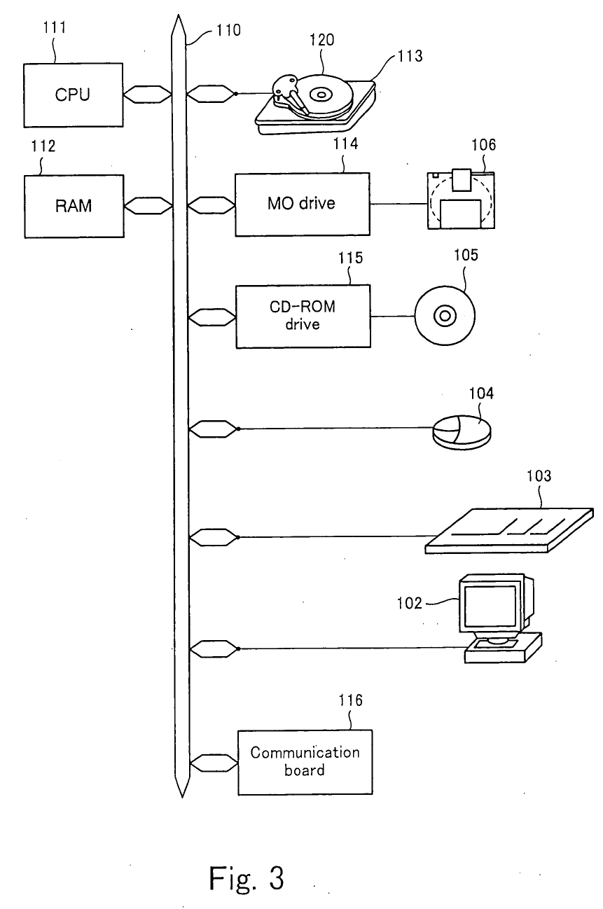

The main unit 101 incorporates a CD-ROM drive that reproduces information stored in a CD-ROM 105 (not shown in FIG. 1, see FIG. 3) or CD-R that is removably loaded thereto. In addition, the main unit 101 incorporates a magneto-optical (MO) drive that records information on or reproduces information in an MO disk 106 (not shown in FIG. 1, see FIG. 2) that is removably loaded thereto.

FIG. 3 shows a hardware configuration of the computer serving as the image data converter 100.

Referring to this drawing, there are shown a central processing unit (CPU) 111, a RAM 112, a hard disk drive (HDD) 113, an MO drive 114, a CD-ROM drive 115 and a communication board 116, which are interconnected via a bus 110.

The HDD 113 incorporates a hard disk 120, which is a kind of recording medium, and information is recorded on or reproduced from the hard disk 120.

The communication board 116 is connected to a communication line, such as a local area network (LAN). Connected to the communication network 250 via the communication board 116, the image data converter 100 shown in FIG. 1 can transmit data to or receive data from another computer system and output image data to the proofer 200.

In addition, FIG. 3 shows the mouse 104, the keyboard 103 and the CRT display 102 shown also in FIG. 1, which are connected to the bus 110 via their respective I/O interfaces (not shown).

Here, the CD-ROM 105 is an image data conversion program storage medium according to an embodiment of the present invention and stores an image data conversion program. The CD-ROM 105 is loaded into the main unit 101, and the image data conversion program stored in the CD-ROM 105 is read by the CD-ROM drive 115 and installed in the hard disk 120 via the bus 110.

When the image data conversion program installed in the hard disk 120 is activated, the image data conversion program is loaded from the hard disk 120 to the RAM 112 and executed by the CPU 111. Once the image data conversion program of the present invention is activated and executed, the computer system 100 operates as the image data converter according to an embodiment of the present invention. That is, a combination of a computer and an image data conversion program of the present invention constitutes an image data converter according to an embodiment of the present invention.

FIG. 1 shows the CD-ROM 105 as an example of the image data conversion program storage medium. However, the image data conversion program storage medium according to the present invention is not limited to the CD-ROM, and other recording media, such as an optical disk, an MO, a flexible disk (FD) and a magnetic tape, may be used.

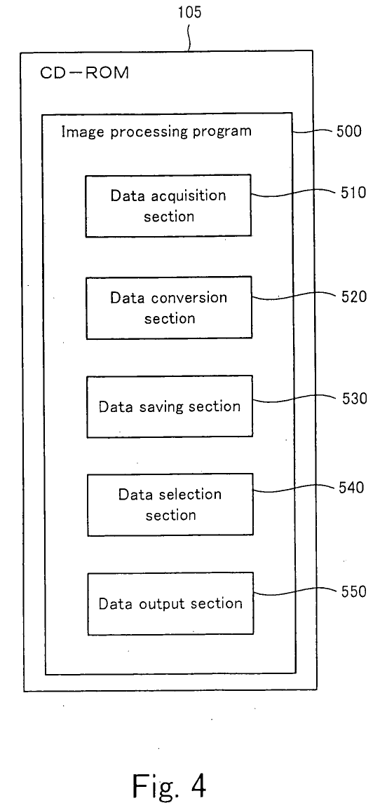

FIG. 4 shows an image data conversion program storage medium according to an embodiment of the present invention. Here, an image data conversion program 500 is stored in the CD-ROM 105.

The image data conversion program 500 is executed in the computer shown in FIG. 1 to make the computer operate as the image data converter 100 shown in FIG. 1. The image data conversion program 500 has a data acquisition section 510, a data conversion section 520, a data saving section 530, a data selection section 540, and a data output section 550.

Of the components, the data acquisition section 510 and the data conversion section 520 are examples of a data acquisition section and a data conversion section according to the present invention, respectively. Furthermore, the data selection section 540 and the data output section 550 constitute a data output section according to the present invention.

The components of the image data conversion program 500 will be described in detail later.

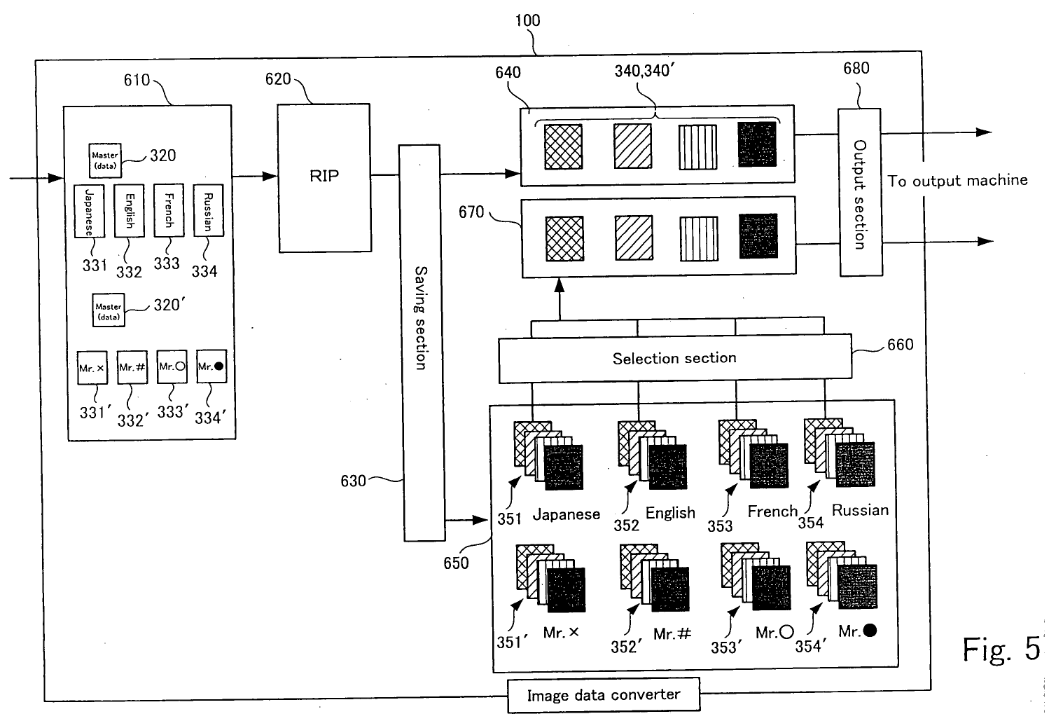

FIG. 5 is a functional block diagram of the image data converter 100 shown in FIG. 1.

The image data converter 100 is implemented by a computer with the image data conversion program 500 shown in FIG. 4 installed and executed therein.

The image data converter 100 has a data acquisition section 610, a data conversion section 620, a data saving section 630, a data selection section 660 and a data output section 680. In addition, the image data converter 100 has a master data storage section 640, a replacement data storage section 650 and a to-be-output variable data storage section 670.

The data acquisition section 610, the data conversion section 620, the data saving section 630, the data selection section 660 and the data output section 680 correspond to the data acquisition section 510, the data conversion section 520, the data saving section 530, the data selection section 540 and the data output section 550 of the image data conversion program 500 shown in FIG. 4, respectively. However, while the components shown in FIG. 5 are implemented by combinations of the hardware of the computer and the OS or application programs executed in the computer, the components of the image data conversion program shown in FIG. 4 are implemented only by application programs. Furthermore, as the master data storage section 640, the replacement data storage section 650 and the to-be-output variable data storage section 670 shown in FIG. 5, the hard disk drive (HDD) 113 shown in FIG. 2 or the like serves.

Of the components, the data acquisition section 610, the data conversion section 620, the master data storage section 640, the replacement data storage section 650, the data selection section 660, and the data output section 680 are examples of a data acquisition section, a data conversion section, a master data storage section, a variable data storage section, a variable data selection section, and a data output section according to the present invention, respectively.

In the following, the components of the image data converter 100 shown in FIG. 5 will be described. The description can apply also to the components of the image data conversion program 500 shown in FIG. 4.

The data acquisition section 610 of the image data converter 100 shown in FIG. 5 receives image data edited by the editor device 300 or 400 shown in FIG. 1 and transmitted there from via the communication network 250. In this example, it is supposed that the image data 310 shown in Part (A) of FIG. 2 is transmitted, and the data acquisition section 610 acquires one piece of master data 320 and four pieces of variable data 331, . . . , 334 each for corresponding one of the four languages. The master data and the variable data are transmitted to the data conversion section 620.

The data conversion section 620 functions as a raster image processor (RIP). In this embodiment, the data conversion section 620 serves to separate an image into four colors of C, M, Y and K but does not perform dot generation, which is performed by a typical RIP. The data conversion section 620 produces separate plate images of C, M, Y and K colors and produces image data that represents an image as a collection of the separate plate images. The image data that represents an image as a collection of separate plate images will be referred to as “separate-plate data”, hereinafter. If the data acquisition section 610 transmits one piece of master data 320 and four pieces of variable data 331, . . . , 334 to the data conversion section 620, the data conversion section 620 handles each of the master component represented by the master data and the variable components represented by the variable data as a color-separation-target image and produces one piece of master separate-plate data representing the master component and four pieces of variable separate-plate data representing the variable components of the four versions of the printing. Here, the master component typically contains continuous-tone data, so that the master separate-plate data represents the master component by continuous tone values. On the other hand, the variable component is primarily composed of line works, so that the variable separate-plate data represents the variable component by binary or multilevel discrete tone values. However, the master separate-plate data and the variable separate-plate data are not different in data format, and if the variable component contains continuous-tone data, the variable separate-plate data can be represented by continuous tone values.

The data saving section 630 receives the separate-plate data produced by the data conversion section 620 and saves one piece of master separate-plate data 340 representing the master component in the master data storage section 640 and four pieces of variable separate-plate data 351, 352, 353 and 354 representing the variable components in the replacement data storage section 650.

The data selection section 660 selects one of the four pieces of variable separate-plate data 351, 352, 353 and 354 saved in the replacement data storage section 650 in accordance with selecting manipulation by the operator via the keyboard 103 or mouse 104 and transmits the selected data to the to-be-output variable data storage section 670 for saving. As a result, one version of the image that can be regarded as a combination of the master component represented by the master separate-plate data 340 saved in the master data storage section 640 and the variable component represented by the variable separate-plate data saved in the to-be-output variable data storage section 670 is determined as an image to be output.

The data output section 680 outputs the master separate-plate data 340 saved in the master data storage section 640 to the continuous-tone (CT) input line of the proofer 200 shown in FIG. 1 and outputs the variable separate-plate data saved in the to-be-output variable data storage section 670 to the line-work (LW) input line of the proofer 200. Here, it is to be noted that, while FIG. 5 shows two arrows representing the two input lines for discriminating between the input lines, the input lines are to receive input data via common hardware as described above.

Then, the proofer 200 overlays the master component and the variable component, thereby producing a proof image corresponding to one version of the printing.

If the operator desires output of a proof image corresponding to a different version of the printing, the operator selects a variable component of that different version through selecting manipulations via the keyboard 103 or mouse 104 shown in FIG. 1. The data selection section 660 transmits the variable separate-plate data representing the selected variable component to the to-be-output variable data storage section 670, in which the previous variable separate-plate data is overwritten. Here, the master data saved in the master data storage section 640 is maintained. As a result, that different version of the printing with the variable component replaced with the selected one is determined as a version to be output. The master separate-plate data and the variable separate-plate data representing that different version of the printing thus determined are output from the data output section 680 to the CT input line and the LW input line of the proofer 200, respectively. Then, the proofer 200 produces a proof image corresponding to that different version of the printing.

Also, the above-described process is similarly carried out when the image data 310′ is transmitted to the data acquisition section 610 and the data acquisition section 610 acquires one piece of master data 320′ and four pieces of variable data 331′, . . . , 334′ each for corresponding one of the four destinations. Specifically, one piece of master separate-plate data 340′ is produced from one piece of master data 320′ and saved in the master data storage section 640, whereas four pieces of variable separate-plate data 351′, 352′, 353′ and 354′ each representing corresponding one of the four destinations are created from four pieces of variable data 331′, . . . , 334′ and saved in the replacement data storage section 650. Subsequently, one of the four pieces of variable separate-plate data 351′, . . . , 354′ is selected and output to the input lines of the proofer 200 shown in FIG. 1 together with the master separate-plate data 340′ saved in the master data storage section 640. The proofer 200 then produces a proof image corresponding to one of the destinations.

As described above, according to this embodiment, the master separate-plate data can be shared among plural versions. Therefore, it is possible to eliminate redundant color separation processings in the data conversion section 620 (RIP) and thus to produce proof images for plural versions easily and efficiently.

Here, in the example described above, image data according to the present invention acquired by the image data converter is in the form of a group of data containing one piece of master data and plural pieces of variable data. However, according to the present invention, the image data converter may acquire image data in the form of a pair of one piece of master data and one piece of variable data.

In addition, in the above description, image data representing the master component by a process color and the variable component by a spot color is taken as an example of the image data according to the present invention. However, the image data according to the present invention may be any image data in any form of representation in which the master component and the variable component are discriminated.

In addition, in the above description, an output section that determines the variable component specified by the operator through selecting manipulations as one to be output is taken as an example of the output section according to the present invention. However, the output section according to the present invention may be one that automatically selects the variable component to be output by itself. For example, the output section according to the present invention may automatically select the versions one by one and output the versions successively.

In addition, in the above description, a proofer that outputs an image represented by four colors of C, M, Y and K is taken as an example of the image output device according to the present invention. However, the image output device according to the present invention can output an image not only by the four colors of C, M, Y and K but also by three colors of C, M and Y or of R, G and B and may be a printing machine other than a proofer, such as a printing machine for on-demand printing.

In addition, in the above description, a proofer having only two input lines for continuous-tone data and line-work data is taken as an example of the image output device according to the present invention. However, the image output device according to the present invention may have three or more input lines including ones for continuous-tone data and line-work data.

In addition, in the embodiments described above, the master separate-plate data is output to the continuous-tone input line, and the variable separate-plate data is output to the line-work input line. However, according to the present invention, the master separate-plate data may be output to the line-work input line, and the variable separate-plate data may be output to the continuous-tone input line.

In addition, in the embodiments described above, the CD-ROM is taken as an example of the image data conversion program storage medium according to the present invention. However, the image data conversion program storage medium according to the present invention may be any kind of storage medium that can store a program. For example, a magnetic disk of a hard disk device, a flexible disk, an MO disk, a DVD, or a card-type or tape-type storage medium may be used.

1. An image data converter that converts input image data representing an image in a first format into to-be-output image data in a second format suitable for output by a predetermined image output device that receives image data via a continuous-tone input line and a line-work input line and outputs a composite image obtained by overlaying images represented by the image data, the image data converter comprising:
a data acquisition section that acquires input master data and input variable data, the master data representing a master component of a plurality of versions of the image that are partially common, which is a component common among the versions, in the first format, and the variable data representing variable components of the plurality of versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

2. The image data converter according to claim 1, wherein the data acquisition section acquires input master data representing the master component by a process color and input variable data representing the variable component by a spot color.

3. The image data converter according to claim 1, wherein the data conversion section converts the input master data and the input variable data in the first format into the to-be-output master data and the to-be-output variable data in the second format so as to obtain common to-be-output master data and plural pieces of to-be-output variable data,
wherein the image data converter further comprises:
a master data storage section that stores the common to-be-output master data;
a variable data storage section that stores the plural pieces of to-be-output variable data; and,
a variable data selection section that selects one of the plural pieces of to-be-output variable data stored in the variable data storage section, and
wherein the output section outputs the to-be-output data stored in the master data storage section and the one piece of to-be-output variable data selected by the variable data selection section.

4. An image data converter that converts input image data representing an image in a first format into to-be-output image data in a second format suitable for output by a predetermined image output device that receives image data via a plurality of input lines and outputs a composite image obtained by overlaying images represented by the image data, the image data converter comprising:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plurality of input lines of the image output device.

5. An image data conversion program storage medium that stores an image data conversion program that is incorporated in a computer system and makes the computer system convert input image data representing an image in a first format into to-be-output image data in a second format suitable for output by a predetermined image output device that receives image data via a continuous-tone input line and a line-work input line and outputs a composite image obtained by overlaying images represented by the image data, the image data conversion program comprising:
a data acquisition section that acquires input master data and input variable data, the master data representing a master component of a plurality of versions of the image that are partially common, which is a component common among the versions, in the first format, and the variable data representing variable components of the plurality of versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

6. An image data conversion program storage medium that stores an image data conversion program that is incorporated in a computer system and makes the computer system convert input image data representing an image in a first format into to-be-output image data in a second format suitable for output by a predetermined image output device that receives image data via a plurality of input lines and outputs a composite image obtained by overlaying images represented by the image data, the image data conversion program comprising:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plurality of input lines of the image output device.

7. An image output system that has a predetermined image output device that receives image data via a continuous-tone input line and a line-work input line and outputs a composite image obtained by overlaying images represented by the image data, converts input image data representing an image in a first format into to-be-output image data in a second format suitable for output by the image output device, and outputs the image from the image output device, the image output system comprising:
a data acquisition section that acquires input master data and input variable data, the master data representing a master component of a plurality of versions of the image that are partially common, which is a component common among the versions, in the first format, and the variable data representing variable components of the plurality of versions of the image, which are components differing among the versions, in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the input lines of the image output device.

8. An image output system that has a predetermined image output device that receives image data via a plurality of input lines and outputs a composite image obtained by overlaying images represented by the image data, converts input image data representing an image in a first format into to-be-output image data in a second format suitable for output by the image output device, and outputs the image from the image output device, the image output system comprising:
a data acquisition section that acquires input master data and input variable data, the master data representing a master component of a plurality of versions of the image that are partially common, which is a component common among the versions, by process colors in the first format, and the variable data representing variable components of the plurality of versions of the image, which are components differing among the versions, by a spot color in the first format;
a data conversion section that converts the input master data and the input variable data acquired at the data acquisition section into to-be-output master data and to-be-output variable data in the second format, respectively; and
a data output section that outputs the to-be-output master data and the to-be-output variable data in the second format that have been converted by the data conversion section to the plurality of input lines of the image output device.
